(19) United States
(12) Patent Application Publication
(10) Pub. No.: US 2008/0309763 A1
(43) Pub. Date: Dec. 18, 2008

(54) Driving Support System And Vehicle

(75) Inventor: Hitoshi Hongo, Shijonawate City (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Moriguchi City (JP)

(21) Appl. No.: 12/104,999

(22) Filed: Apr. 17, 2008

(30) Foreign Application Priority Data
Apr. 18, 2007 (JP) JP2007-109206

(51) Int. Cl. H04N 7/18

(52) U.S. Cl. 348/148; 348/E07.085

(57) ABSTRACT

Disclosed is a driving support system. With this system, a vehicle including a camera installed thereon is arranged at the center of a parking lot defined by two parallel white lines. End points of the respective white lines are included in the field of view of the camera. While the vehicle is moving forward, first and second editing images are obtained respectively at first and second points different from each other. Two end points of each of the editing images are detected as four feature points in total. Image transformation parameters for causing the center line of the vehicle and the center line of the image to coincide with each other are found on the basis of coordinate values of the four feature points on each of the editing images. An output image is obtained by use of the found image transformation parameters.

### CROSS REFERENCE TO RELATED APPLICATION

Applicant claims, under 35 U.S.C. .sctn. 119, the benefit of priority of the filing date of Apr. 18, 2007, of a Japanese Patent Application No. P 2007-109206, filed on the aforementioned date, the entire contents of which are incorporated herein by reference.

### BACKGROUND OF THE INVENTION

1. Field of the Invention

The present invention relates to a driving support system for supporting the driving of a vehicle. The present invention also relates to a vehicle using the system.

2. Description of the Related Art

Heretofore, a large number of systems for providing visibility support to a driver have been developed. In these systems, a image captured by an on-vehicle camera installed on a rear portion of a vehicle and is displayed on a display provided near the driving seat to provide a good field of view to the driver. In this type of systems, due to the limitation of the structure or the design of the vehicle or an installation error of the camera, the camera is installed at a position shifted from the center of the rear portion of the vehicle in some cases (refer to FIG. 3B). In some other cases, the optical axis direction of the camera is shifted from the traveling direction of the vehicle (refer to FIG. 3A).

When the position of the camera is shifted from the center of the rear portion of the vehicle, the centers of the image captured by the camera and of the vehicle do not coincide with each other on the display screen. Moreover, when the optical axis direction is shifted from the traveling direction of the vehicle, an inclined image is displayed on the display screen (also, the center of the vehicle does not coincide with the center of the image). In such cases, sufficient visibility support is not provided since the driver feels something wrong when driving the vehicle while watching a image having such a misalignment or inclination.

In order to cope with such problems, disclosed in Japanese Patent Application Publication No. 2005-129988 is a technique for correcting a positional deviation of the image, which occurs in a case where a camera is installed at a position shifted from the center of the vehicle. In this technique, raster data is divided into two sets corresponding to left and right portions, and the two raster data sets are expanded or contracted according to the offset amount of each raster (horizontal linear image) of the image so that the center of the vehicle can be positioned at the center of the image and also that both ends of the vehicle are respectively positioned at both ends of the image.

### SUMMARY OF THE INVENTION

A driving support system according to a first aspect of the present invention obtains images as first and second editing images upon receipt of a given instruction to derive parameters, the images being respectively captured at first and second points, each of the images including two feature points. In this system, in real space, the two feature points included in each of the first and second editing images are arranged at symmetrical positions with respect to a the center line of a vehicle body in a traveling direction of the vehicle, and the first and second points are different from each other due to the moving of the vehicle. The driving support system includes: a camera configured to be installed on a vehicle and capture the images around the vehicle; a feature point position detector configured to detect the positions of four feature points on the first and second editing images, the four points formed of the two feature points included in each of the first and second editing images; an image transformation parameter deriving unit configured to derive image transformation parameters respectively on the basis of the positions of the four feature points; and an image transformation unit configured to generate an output image by transforming each of the images captured by the camera into the output image in accordance with the image transformation parameters, and then to output a picture signal representing the output image to a display unit.

According to the driving support system, even when the installation position of the camera, the optical axis direction thereof or the like is misaligned, it is possible to display an image in which an influence caused by such misalignment is eliminated or suppressed. Specifically, a good visibility support according to various installation cases of the camera can be implemented.

Specifically, the image transformation parameter deriving unit may derive the image transformation parameters in such a manner that causes the center line of the vehicle body and the center line of the image to coincide with each other in the output image.

In particular, in the driving support system, for example, the camera may capture a plurality of candidate images as candidates of the first and second editing images after receiving the instruction to derive the parameters. Moreover, the feature point position detector may define first and second regions different from each other in each of the plurality of candidate images. Then, the feature point position detector may handle a first candidate image of the plurality of candidate images as the first editing image, the first candidate image including the two feature points extracted from the first region, while handling a second candidate image of the plurality of candidate images as the second editing image, the second candidate image including the two feature points extracted from the second region.

Moreover, in the driving support system, for example, first and second parking lanes common in both of the first and second editing images may be formed in parallel with each other on a road surface on which the vehicle is arranged. In addition, the two feature points included in each of the first and second editing images may be end points of each of the first and second parking lanes. Moreover, the feature point position detector may detect the positions of the four feature points by detecting one end point of the first parking lane of each of the first and second editing images and one end point of the second parking lane of each of the first and second editing images.

In addition, for example, the driving support system may further include a verification unit configured to specify any one of the first editing image, the second editing image and an image captured by the camera after the image transformation parameters are derived, as an input image for verification, and then to determine whether or not the image transformation parameters are proper from the input image for verification. Furthermore, in the driving support system, the first and second parking lanes may be drawn on the input image for verification. The verification unit may extract the first and second parking lanes from a transformation image for verification obtained by transforming the input image for verification in accordance with the image transformation parameters, and then determines whether or not the image transformation parameters are proper on the basis of a symmetric property between the first and second parking lanes on the transformation image for verification.

According to the driving support system, whether or not the derived image transformation parameters are proper can be determined, and the result of the determination can be notified to the user. If the derived image transformation parameters are not proper, the processing of deriving image transformation parameters can be performed again. Accordingly, such a feature is advantageous.

A driving support system according to a second aspect of the present invention obtains images as editing images upon receipt of a given instruction to derive parameters, the images each including four feature points. The driving support system includes: a camera configured to be installed on a vehicle and capture the images around the vehicle; an adjustment unit configured to cause the editing images to be displayed on a display unit with adjustment indicators, and to adjust display positions of the adjustment indicators in accordance with a position adjustment instruction given from an outside of the system in order to correspond the display positions of the adjustment indicators on the display screen of the display unit to the display positions of the four feature points; a feature point position detector configured to detect the positions of the four feature points on each of the editing image from the display positions of the adjustment indicators after the adjustments are made; an image transformation parameter deriving unit configured to derive image transformation parameters respectively on the basis of the positions of the four feature points; and an image transformation unit configured to generate an output image by transforming each of the images captured by the camera into the output image in accordance with the image transformation parameters, and then to output a picture signal representing the output image to a display unit. In the system, the image transformation parameter deriving unit derives the image transformation parameters in such a manner that causes a center line of the vehicle body and a center line of the image in a traveling direction of the vehicle to coincide with each other on the output image.

Accordingly, even when the installation position of the camera, the optical axis direction thereof or the like is misaligned, it is possible to display an image in which an influence caused by such misalignment is eliminated or suppressed.

A driving support system according to a third aspect of the present invention obtains images as editing images upon receipt of a given instruction to derive parameters, the images each including four feature points. The driving support system includes: a camera configured to be installed on a vehicle and capture the images around the vehicle; a feature point position detector configured to detect positions of the four feature points on each of the editing images, which are included in each of the editing images; an image transformation parameter deriving unit configured to derive image transformation parameters respectively on the basis of the positions of the four feature points; and an image transformation unit configured to generate an output image by transforming each of the images captured by the camera into the output image in accordance with the image transformation parameters, and then to output a picture signal representing the output image to a display unit. In the driving support system, the image transformation parameter deriving unit derives the image transformation parameters in such a manner that causes the center line of the vehicle body and the center line of the image in a traveling direction of the vehicle to coincide with each other on the output image.

Accordingly, even when the installation position of the camera, the optical axis direction thereof or the like is misaligned, it is possible to display an image in which an influence caused by such misalignment is eliminated or suppressed.

Specifically, for example, in the driving support system according to any one of the second and third aspects of the invention, the four feature points may be composed of first, second, third and fourth feature points, one straight line connecting the first and second feature points and other straight line connecting the third and fourth points are in parallel with the center line of the vehicle body in real space, and the editing image is obtained in a state where a line passing the center between the one straight line and the other straight line may overlap with the center line of the vehicle body.

Moreover, for example, in the driving support system according to any one of the second and third aspects of the invention, the four feature points may be end points of two parking lanes formed in parallel with each other on a road surface on which the vehicle is arranged.

A vehicle according to the present invention includes a driving support system installed therein according to any one of the aspects described above.

### BRIEF DESCRIPTION OF THE DRAWINGS

FIG. 1A is a plan view seen from above of a vehicle including a visibility support system according to an embodiment of the present invention applied thereto. FIG. 1B is a plane view of the vehicle seen from a lateral direction of the vehicle.

FIG. 2 is a schematic block diagram of the visibility support system according to the embodiment of the present invention.

FIGS. 3A and 3B are diagrams each showing an example of an installation state of a camera with respect to the vehicle.

FIG. 4 is a configuration block diagram of the visibility support system according to a first example of the present invention.

FIG. 5 is a flowchart showing a procedure of deriving image transformation parameters according to the first example of the present invention.

FIG. 6 is a plane view of a periphery of the vehicle seen from above, the plane view showing an editing environment to be set, according to the first example of the present invention.

FIG. 7 is a plane view provided for describing a variation related to a technique for interpreting an end point of a white line.

FIG. 8 is a diagram showing the states of divided regions in an input image, the regions defined being by the end point detector of FIG. 4.

FIGS. 9A and 9B are diagrams respectively showing first and second editing images used for deriving image transformation parameters, according to the first example of the present invention.

FIG. 10A is a diagram showing a virtual input image including end points on each of the first and second editing images of FIGS. 9A and 9B arranged on a single image. FIG. 10B is a diagram showing a virtual output image corresponding to the virtual input image.

FIG. 11 is a diagram showing a correspondence relationship of an input image, a transformation image and an output image.

FIG. 12 is a diagram showing a virtual output image assumed at the time of deriving image transformation parameters.

FIG. 13 is a flowchart showing an entire operation procedure of the visibility support system of FIG. 4.

FIG. 14 is a diagram showing an example of an input image, a transformation image and an output image of the visibility support system of FIG. 4.

FIG. 15 is a configuration block diagram of a visibility support system according to a second example of the present invention.

FIG. 16 is a flowchart showing a procedure of deriving image transformation parameters according to the second example of the present invention.

FIG. 17 is a diagram showing a transformation image for verification according to the second example of the present invention.

FIG. 18 is a configuration block diagram of a visibility support system according to a third example of the present invention.

FIG. 19 is a flowchart showing a procedure of deriving image transformation parameters according to the third example.

FIG. 20 is a plane view of a periphery of the vehicle seen from above, the plane view showing an editing environment to be set, according to the third example of the present invention.

FIG. 21 is a diagram showing an adjustment image to be displayed on a display unit according to the third example of the present invention.

### DETAILED DESCRIPTION OF EMBODIMENTS

Hereinafter, an embodiment of the present invention will be described in detail with reference to drawings. It should be noted that the embodiment to be described below is merely an embodiment of the present invention, so that the definition of the term of each constituent element is not limited to one described in the following embodiment. In each of the drawings to be referred, same or similar reference numerals are given to denote same or similar portions, and basically, an overlapping description of the same portion is omitted herein. Although first to third examples will be described later, subject matters common in the examples or subject matters to be referred in each of the examples will be described, first.

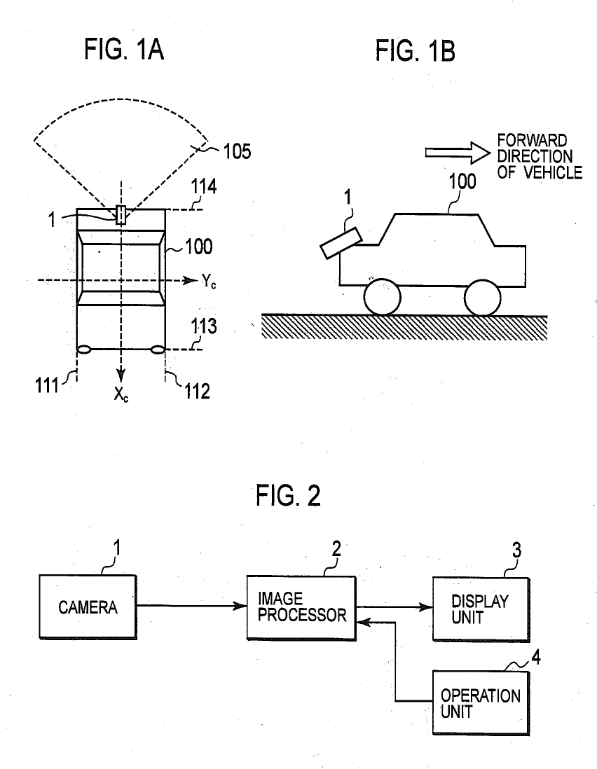

FIG. 1A is a plane view of a vehicle 100 seen from above, the vehicle being an automobile. FIG. 1B is a plane view of the vehicle 100 seen from a lateral direction of the vehicle. The vehicle 100 is assumed to be placed on a road surface. A camera 1 is installed at a rear portion of the vehicle 100, being used for supporting the driver to perform safety check in the backward direction of the vehicle 100. The camera 1 is provided to the vehicle 100 so as to allow the driver to have a field of view around the rear portion of the vehicle 100. A fan-like shape area indicated by a broken line and denoted by reference numeral 105 represents an imaging area (field of view) of the camera 1. The camera 1 is installed in a lower backward direction so that the road surface near the vehicle 100 in the backward direction can be included in the field of view of the camera 1. It should be noted that, although an ordinary motor vehicle is exemplified as the vehicle 100, the vehicle 100 may be a vehicle other than an ordinary motor vehicle (such as a truck). In addition, an assumption is made that the road surface is on a horizontal surface.

Here, an X_{C} axis and a Y_{C} axis each being a virtual axis are defined in real space (actual space) using the vehicle 100 as the basis. Each of the X_{C} axis and Y_{C} axis is an axis on the road surface, and the X_{C} axis and Y_{C} axis are orthogonal to each other. In a two-dimensional coordinate system of the X_{C} axis and Y_{C} axis, the X_{C} axis is in parallel with the traveling direction of the vehicle 100, and the center line of the vehicle body of the vehicle 100 is on the X_{C} axis. For convenience of description, the meaning of the traveling direction of the vehicle 100 is defined as the moving direction of the vehicle 100 when the vehicle 100 moves straight ahead. In addition, the meaning of the center line of the vehicle body is defined as the center line of the vehicle body in parallel with the traveling direction of the vehicle 100. To be more specific, the center line of the vehicle body is a line passing through the center between two virtual lines. One is a virtual line 111 passing through the right end of the vehicle 100 and being in parallel with the X_{C} axis, and the other is a virtual line 112 passing through the left end of the vehicle 100 and being in parallel with the X_{C} axis. In addition, a line passing through the center between two virtual lines is on the Y_{C} axis. One of the virtual lines is a virtual line 113 passing through the front end of the vehicle 100 and being in parallel with the Y_{C} axis, and the other is a virtual line 114 passing through the rear end of the vehicle 100 and being in parallel with the Y_{C} axis. Here, an assumption is made that the virtual lines 111 to 114 are virtual lines on the road surface.

It should be noted that the right end of the vehicle 100 means the right end of the vehicle body of the vehicle 100, and the same applies to the left end or the like of the vehicle 100.

FIG. 2 shows a schematic block diagram of a visibility support system according to the embodiment of the present invention. The visibility support system includes the camera 1, an image processor 2, a display unit 3 and an operation unit 4. The camera 1 captures an image of a subject (including the road surface) located around the vehicle 100 and transmits a signal representing the image obtained by capturing the scene to the image processor 2. The image processor 2 performs image transformation processing involving a coordinate transformation for the transmitted image and generates an output image for the display unit 3. A picture signal representing this output image is provided to the display unit 3. The display unit 3 then displays the output image as a video. The operation unit 4 receives an operation instruction from the user and transmits a signal corresponding to the received operation content to the image processor 2. The visibility support system can also be called as a driving support system for supporting the driving of the vehicle 100.

As the camera 1, a camera with a CCD (Charge Coupled Device) or with a CMOS (Complementary Metal Oxide Semiconductor) image sensor is employed, for example. The image processor 2 is formed of an integrated circuit, for example. The display unit 3 is formed of a liquid crystal display panel or the like, for example. A display unit and an operation unit included in a car navigation system or the like may be used as the display unit 3 and the operation unit 4 in the visibility support system. In addition, the image processor 2 may be integrated into a car navigation system as a part of the system. The image processor 2, the display unit 3 and the operation unit 4 are provided, for example, near the driving seat of the vehicle 100.

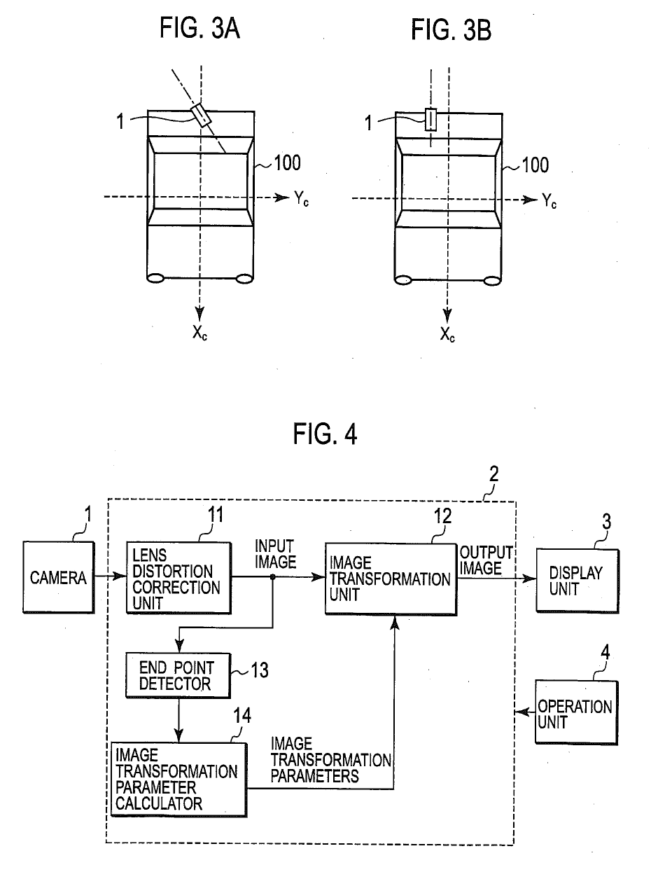

Ideally, the camera 1 is installed precisely at the center of the rear portion of the vehicle towards the backward direction of the vehicle. In other words, the camera 1 is installed on the vehicle 100 so that the optical axis of the camera 1 can be positioned on a vertical surface including the X_{C} axis. Such an ideal installation state of the camera 1 is termed as an “ideal installation state.” In many cases, however, due to the limitation of the structure of or the design of the vehicle 100, or an installation error of the camera 1, the optical axis of the camera 1 may not be in parallel with the vertical surface including the X_{C} axis, as shown in FIG. 3A. In addition, even when the optical axis of the camera 1 is in parallel with the vertical surface including the X_{C} axis, the optical axis may not be on the vertical plane including the X_{C} axis as shown in FIG. 3B.

For convenience of description, the situation where the optical axis of the camera 1 is not in parallel with the vertical surface including the X_{C} axis (in other words, not in parallel with the traveling direction of the vehicle 100) is hereinafter called a “misaligned camera direction.” In addition, the situation where the optical axis is not on the vertical surface including the X_{C} axis is hereinafter called a “camera position offset.” When a misaligned camera direction or camera position offset occurs, the image captured by the camera 1 is inclined from the traveling direction of the vehicle 100 or the center of the image is shifted from the center of the vehicle 100. The visibility support system according to the present embodiment includes functions to generate and to display an image in which such inclination or misalignment of the image is compensated.

### First Example

A first example of the present invention will be described. FIG. 4 is a configuration block diagram of a visibility support system according to the first example. The image processor 2 of FIG. 4 includes components respectively denoted by reference numerals 11 to 14.

A lens distortion correction unit 11 performs lens distortion correction for the image obtained by capturing the scene with the camera 1 and then outputs the image after the lens distortion correction to an image transformation unit 12 and an end point detector 13. The image outputted from the lens distortion correction unit 11 after the lens distortion correction is hereinafter termed as an “input image.” It should be noted that the lens distortion correction unit 11 can be omitted in a case where a camera having no lens distortion or only a few ignorable amounts of lens distortion is used as the camera 1. In this case, the image obtained by capturing the scene with the camera 1 may be directly transmitted to the image transformation unit 12 and the end point detector 13 as an input image.

The image transformation unit 12 generates an output image from the input image after performing image transformation using image transformation parameters calculated by an image transformation parameter calculator 14 and transmits an image signal representing the output image to the display unit 3.

As will be understood from a description to be given later, the output image for the display unit 3 (and a transformation image to be described later) is the image obtained by converting the input image into an image to be obtained when the scene is viewed from the view point of a virtual camera installed on the vehicle 100 in the ideal installation state. Moreover, the inclination of the optical axis of this virtual camera against the road surface is the same (or substantially the same) as that of the actual camera 1. Specifically, the input image is not transformed into an image to be obtained by projecting the input image to the road surface (in other words, conversion into a birds-eye view). The functions of the end point detector 13 and the image transformation parameter calculator 14 will be clear from a description to be given later.

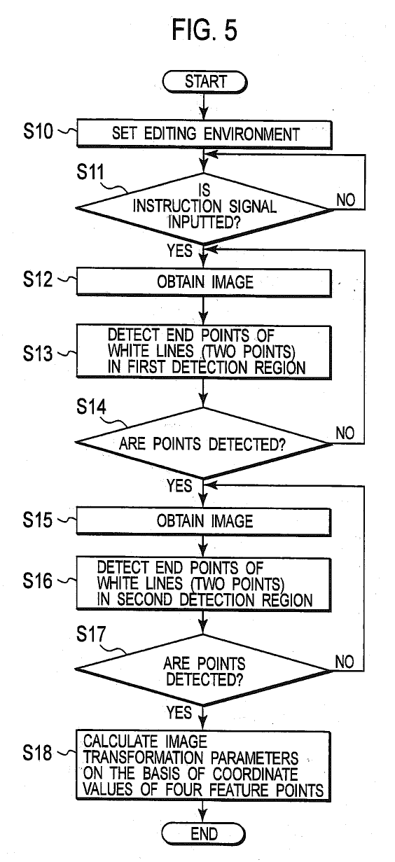

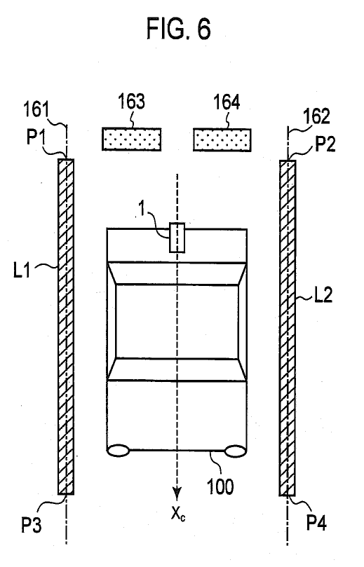

A procedure of deriving the image transformation parameters will be described with reference to FIG. 5. FIG. 5 is a flowchart showing this procedure of deriving the image transformation parameters. First, in step S10, an editing environment of a periphery of the vehicle 100 will be set as follows. FIG. 6 is a plane view of the periphery of the vehicle 100 seen from above, the view showing the editing environment to be set. The editing environment below is an ideal one, however, so that the actual editing environment includes some errors.

The vehicle 100 is placed in a single parking lot in a parking area. The parking lot at which the vehicle 100 is parked is separated from other parking lots by white lines L1 and L2 drawn on the road surface. The white lines L1 and L2 are line segments in parallel with each other and having the same length. The vehicle 100 is parked in such a manner that the X_{C} axis and the white lines L1 and L2 can be in parallel with one another. In actual space, each of the white lines L1 and L2 generally has a width of approximately 10 cm in the Y_{C} axis direction. In addition, the center lines of the white lines L1 and L2 each extending in the X_{C} axis direction are called as center lines 161 and 162, respectively. The center lines 161 and 162 are in parallel with the X_{C} axis. Moreover, the vehicle 100 is arranged at the center of the specified parking lot in such a manner that the distance between the X_{C} axis and the center line 161 can be the same as the distance between the X_{C} axis and the center line 162. Reference numerals 163 and 164 respectively denote curbstones each being placed and fixed at a rear end portion of the road surface of the specified parking lot.

In addition, reference numeral P1 denotes the end point of the white line L1 at the rear side of the vehicle 100. Likewise, reference numeral P2 denotes the end point of the white line L2 at the rear side of the vehicle 100. Reference numeral P3 denotes the end point of the white line L1 at the front side of the vehicle 100. Likewise, reference numeral P4 denotes the end point of the white line L2 at the front side of the vehicle 100. The end points P1 and P3 are located on the center line 161, and the end points P2 and P4 are located on the center line 162. As described, in the actual space, the end points of the white lines L1 and L2 are arranged at symmetrical positions with respect to the X_{C} axis (the center line of the vehicle body of the vehicle 100). In addition, the linear line passing through the end points P1 and P2, and the linear line passing through the end points P3 and P4 are orthogonal to the X_{C} axis.

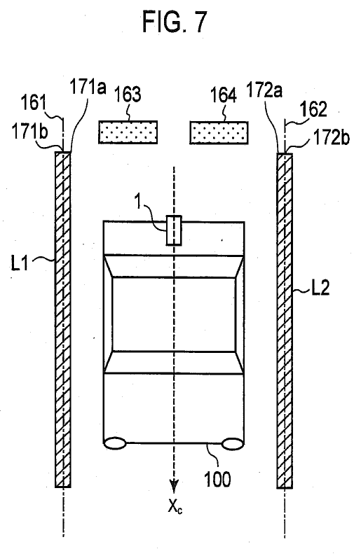

It should be noted that the point on the center line 161 is not necessarily set as P1, and it is also possible to set a point on a position other than the center line 161 as P1. To be precise, the outer shape of the white line L1 is a rectangle, and a corner of the rectangle can be set as P1 (the same applies to P2 to P4). Specifically, as shown in FIG. 7, of the four corners of the rectangle, which is the outer shape of the white line L1, the corner closer to the vehicle 100 is referred to as a corner 171a, and the corner distant from the vehicle 100 is referred to as a corner 171b, both the corners being positioned at the rear side of the vehicle 100. Moreover, of the four corners of the rectangle, which is the outer shape of the white line L2, the corner closer to the vehicle 100 is referred to as a corner 172a, and the corner distant from the vehicle 100 is referred to as a corner 172b, both the corners being positioned at the rear side of the vehicle 100. In this case, the corners 171a and 172a may be set as the end points P1 and P2, respectively. Alternatively, the corners 171b and 172b may be set as the end points P1 and P2, respectively. The same applies to the end points P3 and P4.

In the first example, an assumption is made that the two end points P1 and P2 of the four end points P1 to P4 are included in the field of view of the camera 1, and the description will be thus given, focusing on the two end points P1 and P2. Accordingly, in the following description of the first (and second) example, when terms “end point of white line L1” and “end point of white line L2” are used, these terms refer to “end point P1” and “end point P2,” respectively.

After the editing environment is set in step S10 in the manner described above, the user performs, on the operation unit 4, a predetermined instruction operation for instructing the deriving of image transformation parameters. When the instruction operation is performed on the operation unit 4, a predetermined instruction signal is transmitted to the image processor 2 from the operation unit 4 or a controller (not shown) connected to the operation unit 4.

In step S11, whether or not the instruction signal is inputted to the image processor 2 is determined. In a case where the instruction signal is not inputted to the image processor 2, the processing in step S11 is repeatedly executed. In a case where the instruction signal is inputted to the image processor 2, the procedure moves to step S12.

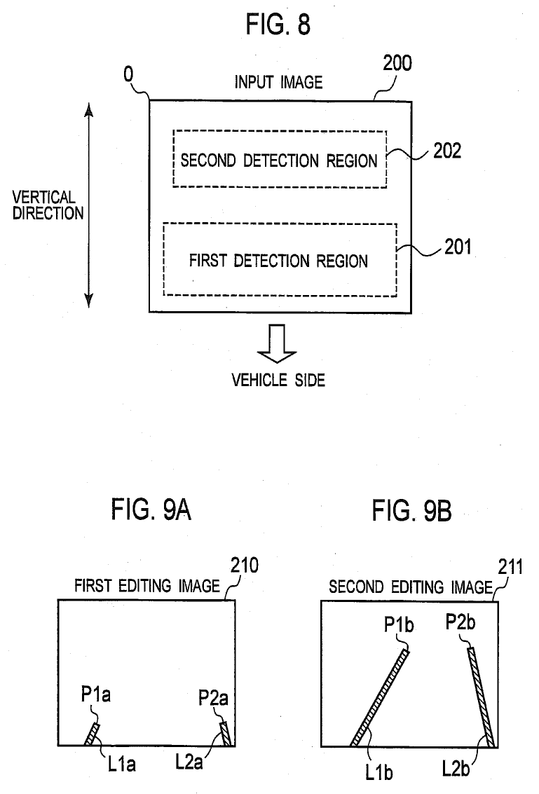

In step S12, the end point detector 13 reads the input image based on the image captured by camera 1 at the current moment, the image having been subjected to the lens distortion correction by the lens distortion correction unit 11. The end point detector 13 defines a first detection region and a second detection region respectively at predetermined positions in the input image, the regions being different from each other as shown in FIG. 8. In FIG. 8, the image in the rectangular region denoted by a reference numeral 200 indicates the input image provided to the end point detector 13, and rectangular regions each indicated by a dashed line and respectively denoted by reference numerals 201 and 202 indicate the first and second detection regions. Each of the first and second regions does not include a region overlapping with that of the other. In addition, the first and second detection regions are aligned in the vertical direction of the input image. The upper left corner of the image is defined as the origin O of the input image. The second detection region is arranged at a position closer to the origin O than the first detection region.

In the input image, an image of a road surface relatively close to the vehicle 100 is drawn in the first detection region positioned in a lower part of the input image. In addition, an image of a road surface relatively distant from the vehicle 100 is drawn in the second detection region positioned in an upper part of the input image.

In step S13 subsequent to step S12, the end point detector 13 detects white lines L1 and L2 from the image in the first detection region of the input image read in step S12, and further extracts endpoints (endpoints P1 and P2 in FIG. 6) respectively of the white lines L1 and L2. Techniques for detecting the white lines in the image and for detecting the end points of the white lines are publicly known. The end point detector 13 can adapt any known technique. A technique described in Japanese Unexamined Patent Application Publications Nos. Sho 63-142478 and Hei 7-78234 or International Patent Publication Number WO 00/7373 may be adapted, for example. For instance, after the edge extraction processing is performed for the input image, straight line extraction processing utilizing Hough transformation or the like is further performed for the result of the edge extraction processing, and then, end points of the obtained straight line is extracted as the end points of the white line.

In step S14 subsequent to step S13, whether or not the end points of the white lines L1 and L2 are detected in the image in the first detection region of the input image is determined. Then, in a case where the two end points are not detected, the procedure returns to step S12, and the processing of steps S12 to S14 is repeated. On the other hand, in a case where the two end points are detected, the procedure moves to step S15.

The input image in which the two end points are detected in step S13 is also particularly termed as a “first editing image.” This first editing image is shown in FIG. 9A. In FIG. 9A, the image in a rectangular region denoted by reference numeral 210 represents the first editing image. Reference numerals L1a and L2a respectively indicate the white lines L1 and L2 on the first editing image. Moreover, points P1a and P2a respectively indicate the end points P1 and P2 on the first editing image. As is clear from the foregoing processing, an input image to be read in step S12 can be called as a candidate for the first editing image.

In step S15, the end point detector 13 reads the input image based on an image captured by camera 1 at the current moment, the image having been subjected to the lens distortion correction by the lens distortion correction unit 11. Incidentally, during the execution of the processing in steps S12 to S17, the user moves the vehicle 100 forward from the position of the vehicle 100 in step S1, the position being as the reference position. Specifically, during the execution of the processing in steps S12 to S17, the user drives the vehicle 100 in a forward direction while simultaneously keeping the two states in which the distance between the X_{C} axis and the center line 161 is the same as the distance between the X_{C} axis and the center line 162 and in which the center lines 161 and 162 are in parallel with the X_{C} axis (refer to FIG. 6). Accordingly, the positions of the vehicle 100 and the camera 1 in real space at the time of execution of step S12 (first point) are different from those of the vehicle 100 and the camera 1 in real space at the time of execution of step S15 (second point).

In step S16 subsequent to step S15, the endpoint detector 13 detects white lines L1 and L2 from the image in the second detection region of the input image read in step S15, and further extracts endpoints (endpoints P1 and P2 in FIG. 6) respectively of the white lines L1 and L2. The technique for detecting the white lines L1 and L2 and the technique for extracting the end points here are the same as those used in step S13. Since the vehicle 100 is moved forward during the execution of the processing in step S12 to S17, the endpoints of the white lines L1 and L2 in the input image read in step S15 should have been respectively shifted to the upper part of the input image as compared with the end points in step S12. Accordingly, the end points of the white lines L1 and L2 can exist in the second detection region of the input image read in step S15.

It should be noted that if the vehicle 100 is not moved during a period between the execution of step S12 and the execution of step S15, the processing to be performed in step S15 and thereafter become meaningless. Accordingly, it is also possible to execute the processing of FIG. 5 with reference to a moving state of the vehicle 100 by detecting the moving state of the vehicle 100 on the basis of vehicle moving information such as a vehicle speed pulse usable to specify a running speed of the vehicle 100. For example, it is possible to configure the procedure not to move to step S15 until the moving of the vehicle 100 to some extent is confirmed after the two end points are detected in step S13. In addition, it is also possible to detect the moving state of the vehicle 100 on the basis of a difference between input images each captured at a different time.

In step S17 subsequent to step S16, whether or not the end points of the white lines L1 and L2 are detected in the image in the second detection region of the input image is determined. Then, in a case where the two end points are not detected, the procedure returns to step S15, and the processing of steps S15 to S17 is repeated. On the other hand, in a case where the two end points are detected, the procedure moves to step S18.

The input image in which the two points are detected in step S16 is also particularly termed as a “second editing image.” This second editing image is shown in FIG. 9B. In FIG. 9B, the image of a rectangular region denoted by reference numeral 211 represents the second editing image. Reference numerals L1b and L2b respectively indicate the white lines L1 and L2 on the second editing image. Moreover, points P1b and P2b on the second editing image respectively indicate the end points P1 and P2 on the second editing image. As is clear from the foregoing processing, an input image to be read in step S12 can be called as a candidate for the second editing image.

The end point detector 13 specifies coordinate values of the end points detected in steps S13 and S16 respectively on the first and second editing images, and then transmits the coordinate values to the image transformation parameter calculator 14. In step S18, the image transformation parameter calculator 14 sets each of the end points as a feature point and calculates an image transformation parameter on the basis of a coordinate value of each feature point (each of the end points) received from the end point detector 13.

The input image including the first and second editing images can be subjected to image transformation (in order words, coordinate transformation) by use of the calculated image transformation parameters. The input image after the image transformation is hereinafter termed as a “transformation image.” As will be described later, a rectangular image cut out from this transformation image becomes an output image from the image transformation unit 12.

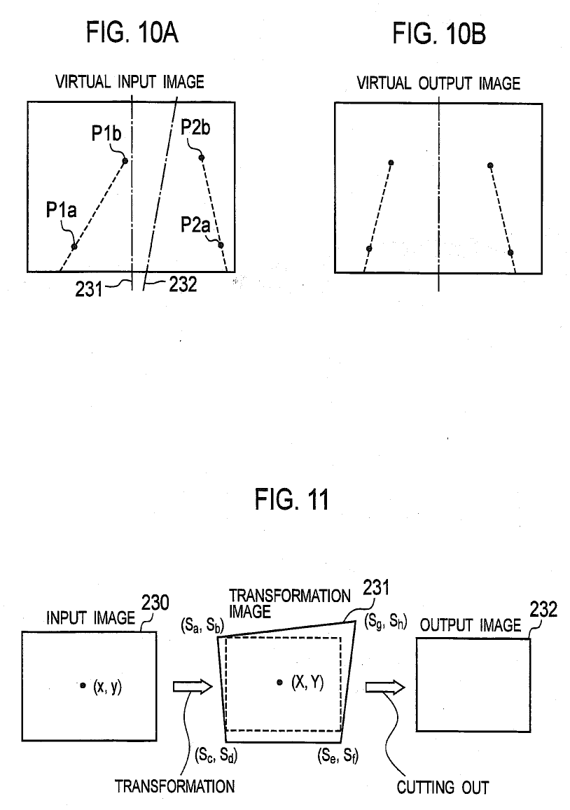

FIG. 10A is a virtual input image including the end points on the first and second editing images as shown respectively in FIGS. 9A and 9B arranged on a single image surface. It can be found that an image center line 231 and a vehicle body center line 232 of the vehicle 100 do not coincide with each other on the image, due to “misaligned camera direction” and “camera position offset”. The image transformation parameter calculator 14 calculates the image transformation parameters so as to obtain a virtual output image from the virtual input image, the virtual output image being shown as FIG. 10B by the image transformation performed on the basis of the image transformation parameters.

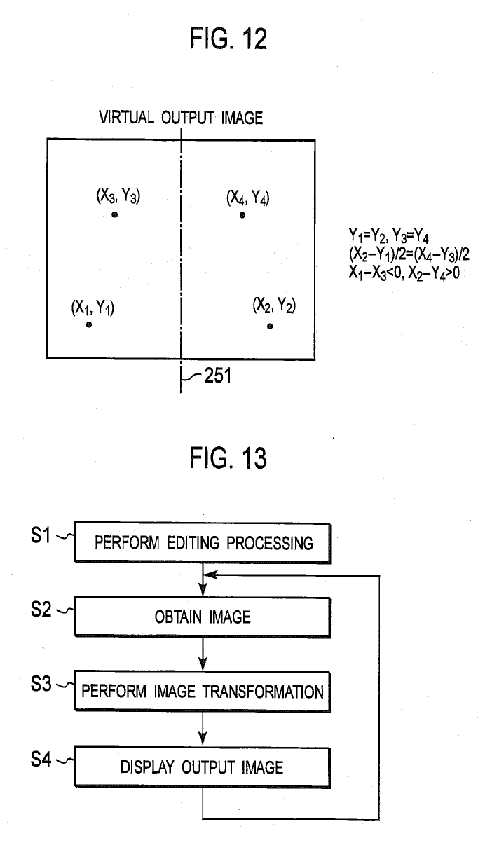

A description will be given of the processing content of step S18 in more detail with reference to FIGS. 11 and 12. In FIG. 11, a rectangular image denoted by reference numeral 230 represents an input image, and a quadrangular image denoted by reference numeral 231 represents a transformation image. Moreover, a rectangular image denoted by reference numeral 232 in FIG. 11 is an output image. The coordinate of each of the points in the input image is expressed by (x, y), and the coordinate of each of the points in the transformation image is expressed by (X, Y). Here, x and X are coordinate values in the horizontal direction of the image, and y and Y are coordinate values in the vertical direction of the image.

The coordinate values of the four corners of the quadrangle forming the outer shape of the transformation image 231 are set to be (Sₐ, S_{b}), (S_{c}, S_{d}), (Sₑ, S_{f}) and (S_{g}, Sₕ), respectively. Accordingly, the relationships between the coordinate (x, y) in the input image and the coordinate (X, Y) in the transformation image are expressed by the following formulae (1a) and (1b).

[Equation 1]

X=(xy)Sₐ+x(1−y)S_{c}+(1−x)ySₑ+(1−x)yS_{g} (1a)

X=(xy)S_{b}+x(1−y)S_{d}+(1−x)yS_{f}+(1−x)ySₕ (1b)

Here, the coordinate values of the end points P1a and P2a detected in step S13 on the first editing image are respectively set to be (x₁, y₁) and (x₂, y₂) (refer to FIG. 9A). Moreover, the coordinate values of the end points P1b and P2b detected in step S16 on the second editing image are respectively set to be (x₃, y₃) and (x₄, y₄) (refer to FIG. 9B). The image transformation parameter calculator 14 handles (x₁, y₁), (x₂, y₂), (x₃, y₃) and (x₄, y₄) as the coordinate values of the four feature points on the input image. In addition, the image transformation parameter calculator 14 defines the coordinates of four feature points on the transformation image corresponding to the four feature points on the input image, following known information that the image transformation parameter calculator 14 recognizes in advance. The defined coordinates are set to be (X₁, Y₁), (X₂, Y₂), (X₃, Y₃) and (X₄, Y₄).

It is also possible to adapt a configuration in which the coordinate values, (X₁, Y₁), (X₂, Y₂), (X₃, Y₃) and (X₄, Y₄) are defined in a fixed manner in advance. Alternatively, these coordinate values may be set in accordance with the coordinate values (x₁, y₁), (x₂, y₂), (x₃, y₃) and (x₄, y₄). In both cases, however, in order to obtain an output image corresponding to the one shown in FIG. 12, eventually, the coordinate values of the four feature points on the transformation image are set to satisfy Y₁=Y₂, Y₃=Y₄ and (X₂−X₁)/2=(X₄−X₃)/2. Furthermore, since the output image is not a birds-eye view image, the followings are true: X₁−X₃<0 and X₂−X₄>0. A birds-eye view image is an image obtained by performing a coordinate transformation on the input image to obtain an image viewed from above the vehicle. It is obtained by projecting the input image onto a road surface not in parallel with the imaging surface.

By assigning coordinate values (xᵢ, yᵢ) and (Xᵢ, Yᵢ) to aforementioned formulae (1a) and (1b) as (x, y) and (X, Y), each value of Sₐ, S_{b}, S_{c}, S_{d}, Sₑ, S_{f}, S_{g} and Sₕ is found in the formulae (1a) and (1b). Once these values are found, any point on an input image can be transformed into a coordinate on a transformation image (here, i is an integer of 1 to 4). Each value of Sₐ, S_{b}, S_{c}, S_{d}, Sₑ, S_{f}, S_{g} and Sₕ corresponds to an image transformation parameter to be calculated.

As shown in FIG. 11, the outer shape of a transformation image is not a rectangle, normally. The output image to be displayed on the display unit 3 is, however, a rectangular region of the image cut out from the transformation image. It should be noted that, in a case where the outer shape of the transformation image is a rectangle or similar shape, the transformation image can be outputted to the display unit 3 as an output image, without the need of forming an output image through the cut out processing.

The position and size of the rectangular region to be cut out from the transformation image are specified from the positions of the four feature points on the transformation image. For example, a method of setting a rectangular region is determined in advance so that the position and size of the rectangular region can be uniquely defined in accordance with the coordinate values of the four feature points on the transformation image. At this time, coordinate values of the center line (line 251 in FIG. 12) of the image in the horizontal direction is set to coincide with (X₂−X₁)/2(=(X₄−X₃)/2), the center line extending in the vertical direction of the image and separating the output image into left and right parts. The center line of the image in the vertical direction and the vehicle body center line of the vehicle 100 thereby coincide with each other in the output image. The vehicle body center line in the output image means a virtual line that appears on the output image when the vehicle body center line defined in real space is arranged on the image surface of the output image. It should be noted that the position and size of the rectangular region may be determined according to the shape of the transformation image to have the maximum size of the rectangular region cut out.

FIG. 13 is a flowchart showing an entire operation procedure of the visibility support system of FIG. 4. In the editing processing of step S1, the processing of steps S10 to S18 of FIG. 5 is performed, and image transformation parameters are thereby calculated. In accordance with the operation at the time when the visibility support system is in actual operation, the processing in steps S2 to S4 is repeatedly executed after the editing processing of step S1.

Specifically, after the editing processing of step S1, in step S2, the image transformation unit 12 reads an input image based on the image captured by the camera 1 at the current moment, the input image having been subjected to lens distortion correction performed by the lens distortion correction unit 11. In step S3 subsequent to step S2, the image transformation unit 12 performs image transformation, on the basis of the image transformation parameters calculated in step S1, for the read input image. Then, the image transformation unit 12 generates an output image through the cutting out processing. The picture signal representing the output image is transmitted to the display device 3, and then, the display unit 3 displays the output image as a video in step S4. The procedure returns step S2 after the processing of step S4.

It should be noted that actually, after step S1, table data showing corresponding relationships between the coordinate values of pixels of the input image and the coordinate values of pixels of the output image is generated in accordance with the calculation result of the image transformation parameters and the cutting method of the output image from the transformation image, for example. The generated table data is then stored in a look up table (LUT) in memory (not shown). Then, by use of the table data, input images are sequentially converted into output images. As a matter of course, it is also possible to adapt a configuration in which an output image is obtained by executing arithmetic operations in accordance with the foregoing formulae (1a) and (1b) every time an input image is provided.

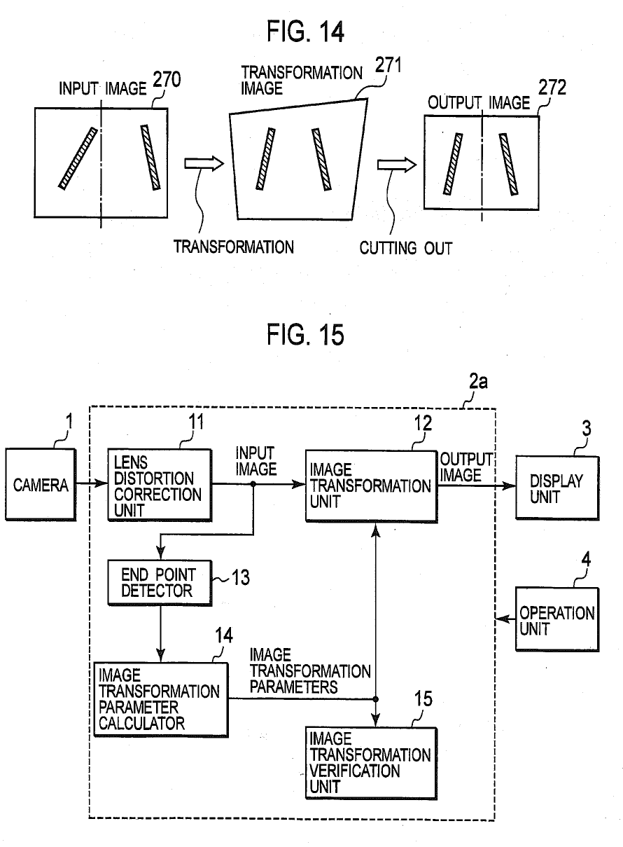

FIG. 14 shows an example of an input image, a transformation image and an output image after image transformation parameters are derived.

In FIG. 14, an assumption is made that the image is captured when the vehicle 100 moves forward from the position shown in FIG. 6. In an input image 270, a transformation image 271 and an output image 272, regions each filled with diagonal lines are the regions in each of which the white lines L1 and L2 are drawn (the curbstone 163 or the like shown in FIG. 6 is omitted, here).

In the input image 270, the center line of the image in the vertical direction is shifted from the vehicle body center line of the vehicle 100 or is inclined due to “misaligned camera direction” or “camera position offset.” For this reason, in the input image 270, the two white lines appears as ones misaligned from the correct positions although the vehicle 100 is parked in the parking lot in such a manner that the center of the vehicle 100 can coincide with the center of the parking lot. The positions of the white lines, however, are corrected in the output image 272. In other words, in the output image 272, the center line of the image in the vertical direction and the vehicle body center line (the vehicle body center line on the image) of the vehicle 100 coincide with each other, and the influence of “misaligned camera direction” or “camera position offset” is eliminated. Accordingly, the image coinciding with the traveling direction of the vehicle can be shown, not causing the driver to feel something wrong. Thereby, the system can appropriately support the driver to have the field of view.

In addition, although the installation position or the installation angle of the camera 1 on the vehicle 100 is often changed, appropriate image transformation parameters can be easily obtained again by only executing the processing of FIG. 5 even in a case where such a change is made.

Moreover, although it becomes difficult to display a region distant from the vehicle in a system that displays a birds-eye view image obtained by projecting an input image onto the road surface, such a projection is not performed in this example (and other examples to be described later). Accordingly, the region distant from the vehicle can be displayed, and the field of view of the region distant from the vehicle can be supported.

Hereinafter, several modified techniques of the foregoing technique according to the first example will be exemplified.

The image transformation by use of the image transformation parameters based on the foregoing formulae (1a) and (1b) corresponds to a nonlinear transformation. However, an image transformation by use of a homography matrix or an affine transformation may be also used. Here, the image transformation by use of a homography matrix will be described as an example. This homography matrix is expressed by H. H is a matrix of three columns by three rows, and the elements of the matrix are expressed by h₁ to h₉, respectively. Furthermore, h₉=1 is set to be true (the matrix is normalized so that h₉=1 can be true). In this case, the relationships between a coordinate (x, y) and a coordinate (X, Y) are expressed by the following formula (2), and also by the formulae (3a) and (3b).

$$\begin{matrix}[ Equation 2 ] & \\ \begin{matrix}( \begin{matrix}X \\ Y \\ 1\end{matrix} ) = H ( \begin{matrix}x \\ y \\ 1\end{matrix} ) \\ = ( \begin{matrix}{h}_{1} & {h}_{2} & {h}_{3} \\ {h}_{4} & {h}_{5} & {h}_{6} \\ {h}_{7} & {h}_{8} & {h}_{9}\end{matrix} ) ( \begin{matrix}x \\ y \\ 1\end{matrix} ) \\ = ( \begin{matrix}{h}_{1} & {h}_{2} & {h}_{3} \\ {h}_{4} & {h}_{5} & {h}_{6} \\ {h}_{7} & {h}_{8} & 1\end{matrix} ) ( \begin{matrix}x \\ y \\ 1\end{matrix} )\end{matrix} & ( 2 ) \\ [ Equation 3 ] & \\ X = \frac{{h}_{1} x + {h}_{2} y + {h}_{3}}{{h}_{7} x + {h}_{8} y + {h}_{9}} & ( 3 a ) \\ Y = \frac{{h}_{4} x + {h}_{5} y + {h}_{6}}{{h}_{7} x + {h}_{8} y + {h}_{9}} & ( 3 b )\end{matrix}$$

If the correspondence relationships of the coordinate values of the four feature points between the input image and the transformation image are found, H can be determined uniquely. As a technique to find the homography matrix H (projective transformation matrix) on the basis of the correspondence relationships of the coordinate values of the four points, a publicly known technique may be used. A technique described in Japanese Patent Application Publication No. 2004-342067 (in particular, refer to the technique described in paragraphs 0059 to 0069) may be used, for example. Specifically, the elements h₁ to h₈ of the homography matrix H are found so that the coordinate values (x₁, y₁), (x₂, y₂), (x₃, y₃) and (x₄, y₄) can be transformed into (X₁, Y₁), (X₂, Y₂), (X₃, Y₃) and (X₄, Y₄), respectively. Actually, the elements h₁ to h₈ are found in such a manner that an error of the transformation (evaluation function in Japanese Patent Application Publication No. 2004-342067) can be minimized.

Once the homography matrix H is found, any point on an input image can be transformed into a point on a transformation image in accordance with the foregoing formulae (3a) and (3b). By use of the homography matrix H as the image transformation parameters, the transformation image (and also the output image) can be generated from the input image.

Moreover, in the method of calculating image transformation parameters, described above with reference to FIG. 5, the assumption is made that the vehicle 100 is moved in the forward direction after the processing of step S10. The same processing, however, can be performed when the vehicle 100 is moved in the backward direction as a matter of course. In this case, as a matter of course, a part of the aforementioned processing content is appropriately changed in accommodation with the change that the vehicle 100 is moved in the backward direction rather than the forward direction.

In addition, in the method of calculating image transformation parameters, described above with reference to FIG. 5, the assumption is made that the end points P1 and P2 of the white lines (refer to FIG. 6) are handled as the feature points. However, by use of first and second markers (not shown) that can be detected on the image by the image processor 2 of FIG. 4, the image transformation parameters may be derived by handling the markers as the feature points. By use of markers, better image transformation parameters can be calculated in a stable manner. The markers on an image can be detected by use of edge extraction processing or the like. For example, the first and second markers are respectively arranged at the same positions as the end points P1 and P2 (in this case, the white lines do not have to be drawn on the road surface). Then, by performing the same processing as that of the aforementioned technique described with reference to FIG. 5, the same image transformation parameters as those obtained in the case where the end points P1 and P2 are used as the feature points can be obtained (the end points P1 and P2 are replaced only with the first and second markers, respectively).

### Second Example

Next, a second example of the present invention will be described. FIG. 15 is a configuration block diagram of a visibility support system according to the second example. The visibility support system of FIG. 15 includes the camera 1, an image processor 2a, the display unit 3 and the operation unit 4. The image processor 2a includes components denoted by reference numerals 11 to 15, respectively. Specifically, except that an image transformation verification unit 15 is added in the configuration of the visibility support system according to the second example, the configuration is the same as that of the visibility support system according to the first example. Except for this point, both of the visibility support systems are the same. Accordingly, a description will be hereinafter given of only functions of the image transform verification unit 15. The matters described in the first example also apply to the second example unless there is a discrepancy.

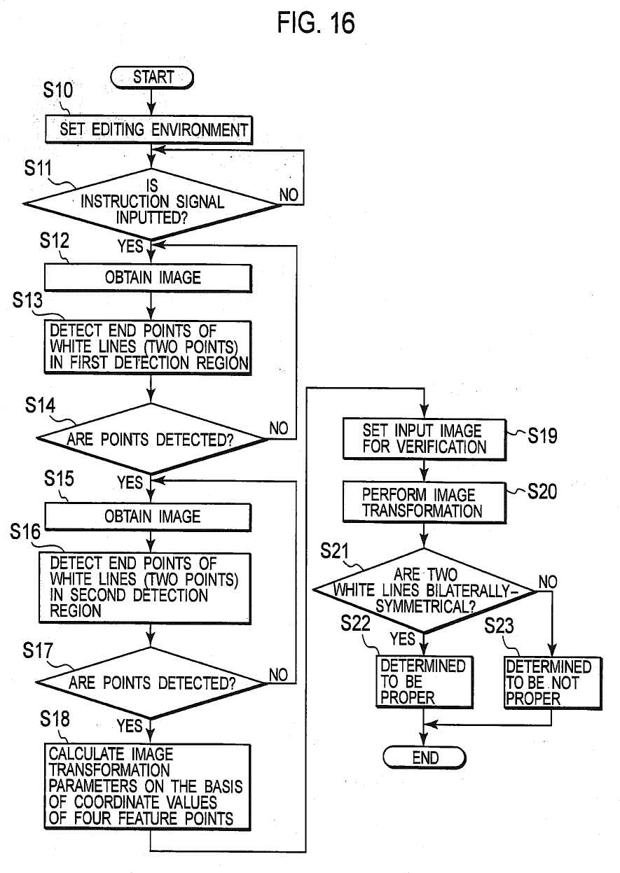

FIG. 16 is a flowchart showing a procedure of deriving image transformation parameters, according to the second example. In FIG. 16, the procedure of deriving image transformation parameters includes the processing of steps S10 to S23. The processing of step S10 to S18 are the same as that of FIG. 5. In the second example, the procedure moves to step S19 after the processing of step S18.

In step S19, an input image for verification is set. Specifically, the first editing image or the second editing image is used as the input image for verification. In addition, the input image after the processing of step S18 can be also used as the input image for verification. In this case, however, an assumption is made that the distance between the X_{C} and the center line 161 coincides with the distance between the X_{C} and the center line 162 and also that both of the center lines 161 and 162 are in parallel with the X_{C} axis (refer to FIG. 6). Furthermore, an assumption is made that the white lines L1 and L2 are drawn in the input image for verification.

In step S20 subsequent to step S19, the image transformation verification unit 15 (or the image transformation unit 12) generates a transformation image by transforming the input image for verification into the transformation image in accordance with the image transformation parameters calculated in step S18. The transformation image generated herein is termed as a verification transformation image.

After the verification transformation image is obtained, the procedure moves to step S21. In step S21, the image transformation verification unit 15 detects the white lines L1 and L2 in the verification transformation image. For example, firstly, the edge extraction processing is performed on the verification transformation image, and secondly, two straight lines are obtained by further executing the straight line extraction processing utilizing Hough transformation or the like with respect to the result of the edge extraction processing. Thirdly, the lines are set to be the white lines L1 and L2 in the verification transformation image. Finally, the image transformation verification unit 15 determines whether or not the two straight lines (specifically, the white lines L1 and L2) are bilaterally-symmetric in the verification transformation image.

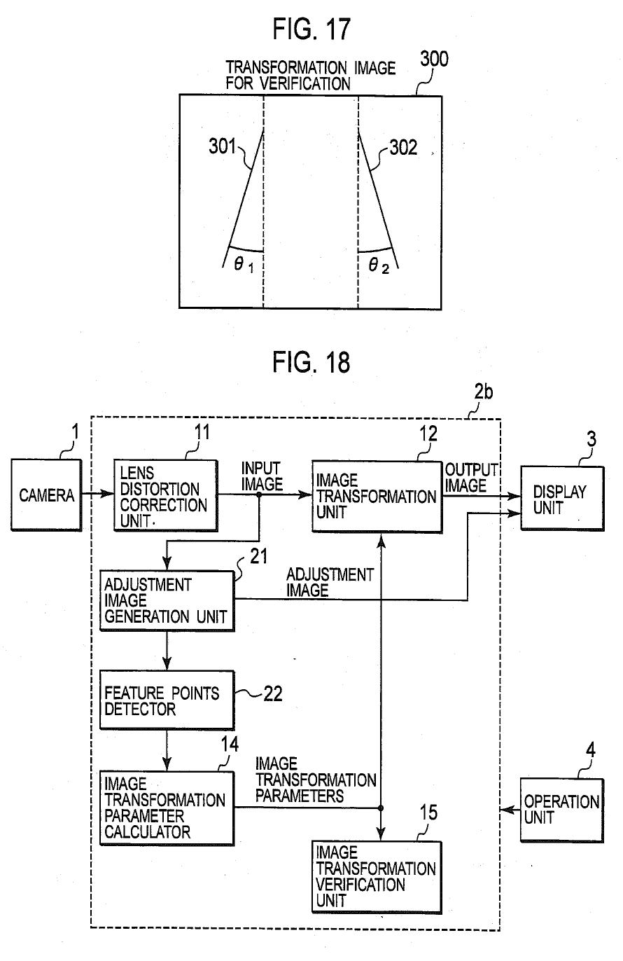

This determination technique will be exemplified with reference to FIG. 17. A verification transformation image 300 is shown in FIG. 17. The straight lines respectively denoted by reference numerals 301 and 302 in the verification transformation image 300 are the white lines L1 and L2 detected in the verification transformation image 300. It should be noted that for the sake of convenience, the outer shape of the verification transformation image 300 is set to be a rectangle, and also, a case where the entire portions of the white lines L1 and L2 are arranged within the verification transformation image 300 is applied in this exemplification.

The image transformation verification unit 15 detects the inclinations of the straight lines 301 and 302 from vertical lines of the verification transformation image. The inclination angles of the straight lines 301 and 302 are respectively expressed by θ₁ and θ₂. The inclination angle θ₁ can be calculated from two different coordinate values on the straight line 301 (the inclination angle θ₂ can be calculated in the same manner). The inclination angle of the straight line 301 when the angle is viewed in a clockwise direction from the corresponding vertical line of the verification transformation image is set to be θ₁, and the inclination angle of the straight line 302 when the angle is viewed in a counterclockwise direction from the vertical line of the verification transformation image is set to be θ₂. Accordingly, the followings are true: 0°<θ₁<90° and 0°<θ₂<90°.

The image transformation verification unit 15 then compares θ₁ and θ₂, and determines that the white lines L1 and L2 (specifically, the straight lines 301 and 302) are bilaterally-symmetric in the verification transformation image in a case where the difference between θ₁ and θ₂ is less than a given reference angle. The image transformation verification unit 15 thus determines that the image transformation parameters calculated in step S18 are proper (step S22). In this case, the calculation of the image transformation parameters in FIG. 16 ends normally, and the processing of steps S2 to S4 of FIG. 13 is executed thereafter.

On the other hand, in a case where the difference between θ₁ and θ₂ is equal to or greater than the aforementioned given reference angle, the image transformation verification unit 15 determines that the white lines L1 and L2 (specifically, the straight lines 301 and 302) are not bilaterally-symmetric in the verification transformation image. The image transformation verification unit 15 thus determines that the image transformation parameters calculated in step S18 are not proper (step S23). In this case, the user is notified of the situation by the display unit 3 or the like displaying an alert corresponding to the event that the calculated image transformation parameters are not appropriate.

By including the image transformation verification unit 15 in the system, whether or not the calculated image transformation parameters are appropriate can be determined, and the result of the determination can also be notified to the user. The user notified that the calculated image transformation parameters are not appropriate is allowed to use a remedy by executing the editing processing again for obtaining appropriate image transformation parameters.

### Third Example

Next, a third example of the present invention will be described. FIG. 18 is a configuration block diagram of a visibility support system according to the third example. The visibility support system of FIG. 18 includes the camera 1, an image processor 2b, the display unit 3 and the operation unit 4. The image processor 2b includes components respectively denoted by reference numerals 11, 12, 14, 15, 21 and 22.

The functions of the lens distortion correction unit 11, the image transformation unit 12, the image transformation parameter calculator 14 and the image transformation verification unit 15 are the same as those described in the first or the second example.

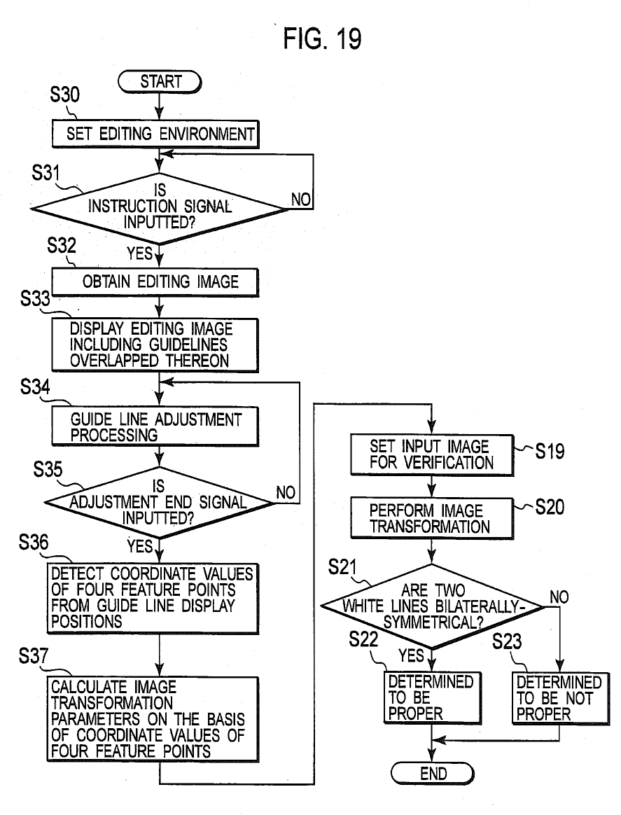

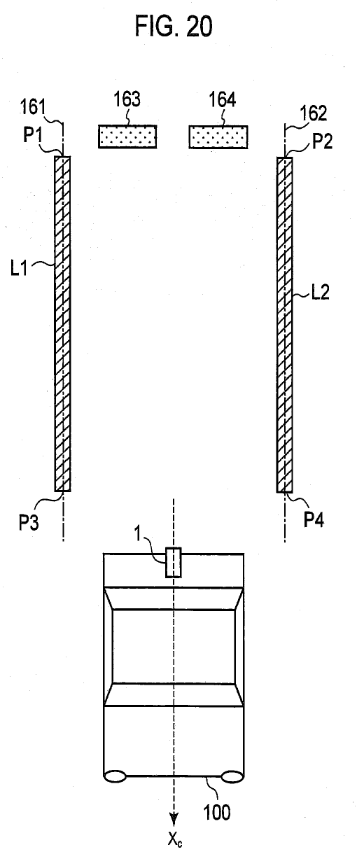

A procedure of deriving image transformation parameters according to this example will be described with reference to FIG. 19. FIG. 19 is a flowchart showing this procedure of deriving image transformation parameters. First, in step S30, the editing environment of a periphery of the vehicle 100 is set in a manner described below. FIG. 20 is a plane view of the periphery of the vehicle 100 seen from above, the view showing the editing environment to be set. The editing environment below is an ideal one, however, so that the actual editing environment includes some errors.

The editing environment to be set in step S30 is similar to the one to be set in step S10 of the first example. In step S30, the vehicle 100 is moved forward in the editing environment by using the one to be set in step S10 as the reference, so that both end points of each of the white lines L1 and L2 are included in the field of view of the camera 1. The processing in step S30 is the same as that of step S10 except this processing. Accordingly, the distance between the X_{C} axis and the center line 161 is the same as the distance between the X_{C} axis and the center line 162, and also that both of the center lines 161 and 162 are in parallel with the X_{C} axis.

When the editing environment is set in step S30, the end points of the white lines L1 and L2, which are distant from the vehicle 100, become P1 and P2, respectively, and the end points of the white lines L1 and L2, which are closer to the vehicle 100, become P3 and P4, respectively. In addition, an assumption is made that the vehicle 100 does not move during the process of calculation of the image transformation parameters to be performed after step S30.

After the editing environment is set in step S30 in the manner described above, the user performs a given instruction operation for instructing the deriving of the image transformation parameters on the operation unit 4. When this instruction operation is performed on the operation unit 4, a predetermined instruction signal is transmitted to the image processor 2b from the operation unit 4 or a controller (not shown) connected to the operation unit 4.

In step S31, whether or not this instruction signal is inputted to the image processor 2b is determined. In a case where this instruction signal is not inputted to the image processor 2b, the processing of step 31 is repeatedly executed. On the other hand, in a case where this instruction signal is inputted to the image processor 2b, the procedure moves to step S32.

In step S32, an adjustment image generation unit 21 reads an input image based on the image captured by the camera 1 at the current moment, the input image having been subjected to lens distortion correction performed by the lens distortion correction. The read input image herein is termed as an editing image. Then, in step S33, the adjustment image generation unit 21 generates an image including two guidelines overlapped on this editing image. This generated image is termed as an adjustment image. Furthermore, a picture signal representing the adjustment image is outputted to the display unit 3. Thereby, the adjustment image is displayed on the display screen of the display unit 3. Thereafter, the procedure moves to step S34, and guideline adjustment processing is performed.

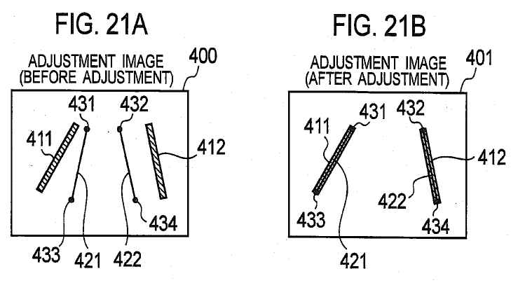

FIGS. 21A and 21B show examples of adjustment images to be displayed. Reference numeral 400 in FIG. 21A denotes an adjustment image before the guideline adjustment processing is performed. Reference numeral 401 in FIG. 21B denotes an adjustment image after the guideline adjustment processing is performed. In FIGS. 21A and 21B, regions each being filled with diagonal lines and being respectively denoted by reference numerals 411 and 412 are the regions in which the white lines L1 and L2 are respectively drawn on each of the adjustment images. The entire portions of the white lines L1 and L2 are arranged within each of the adjustment images. The lines respectively denoted by reference numerals 421 and 422 on each of the adjustment images are guidelines on the adjustment images. When the user performs a given operation on the operation unit 4, a guideline adjustment signal is transmitted to the adjustment image generation unit 21. The adjustment image generation unit 21 changes display positions of end points 431 and 433 of the guideline 421 and those of end points 432 and 434 of the guideline 422, individually in accordance with the guideline adjustment signal.

The processing of changing the display positions of the guidelines in accordance with the given operation described above is the guideline adjustment processing executed in step S34. The guideline adjustment processing is performed until an adjustment end signal is transmitted to the image processor 2b (step S35). The user operates the operation unit 4 in order that the display positions of the end points 431 and 433 of the guideline 421 can coincide with corresponding end points of the white line 411 (in other words, the end points P1 and P3 of the white line L1 on the display screen) and that the display positions of the end points 432 and 434 of the guideline 422 can coincide with corresponding end points of the white line 412 (in other words, the end points P2 and P4 of the white line L2 on the display screen). Upon completion of this operation, the user performs a given operation for ending the adjustment on the operation unit 4. Thereby, an adjustment end signal is transmitted to the image processor 2b, and the procedure thus moves to step S36.

In step S36, the feature point detector 22 specifies, from the display positions of the end points 431 to 434 at the time when the adjustment end signal is transmitted to the image processor 2b, coordinate values of the end points 431 to 434 on the editing image at this time point. These four end points 431 to 434 are feature points on the editing image. Then, the coordinate values of the end points 431 and 432 specified in step S36 are set to be (x₃, y₃) and (x₄, y₄), respectively, and the coordinate values of the end points 433 and 434 also specified in step S36 are set to be (x₁, y₁) and (x₂, y₂), respectively. These coordinate values are transmitted to the image transformation parameter calculator 14 as the coordinate values of the feature points. Then, the procedure moves to step S37.

In step S37, the image transformation parameter calculator 14 calculates image transformation parameters on the basis of the coordinate values (x₁, y₁), (x₂, y₂), (x₃, y₃) and (x₄, y₄) of the four feature points on the editing image and coordinate values (X₁, Y₁), (X₂, Y₂), (X₃, Y₃) and (X₄, Y₄) based on known information. The methods of defining this calculation technique and the coordinate values (X₁, Y₁), (X₂, Y₂), (X₃, Y₃) and (X₄, Y₄) are the same as those described in the first example (refer to FIG. 12). Thereafter, a transformation image is obtained by transforming the input image into the transformation image in accordance with the image transformation parameters, and then, an output image is generated by cutting out a rectangular region from the obtained transformation image. The method of cutting out the rectangular region from the transformation image is also the same as that used in the first example. Accordingly, as in the case of the first example, the center line of the image in a vertical direction and the vehicle body center line of the vehicle 100 (the line 251 in FIG. 12) coincide with each other in the output image. Incidentally, as described in the first example, it is also possible to output the transformation image to the display unit 3 as the output image without performing the cutting out processing.

The procedure moves to step S19 after step S37. The processing of step S19 to S23 is the same as that of the second example. In this example, the input image for detection to be set in step S19 becomes the aforementioned editing image. Furthermore, the input image after the processing of step S37 can be also set to be the input image for detection, provided that the input image for detection is to be captured when the conditions of the editing environment to be set in step S30 are satisfied.

In step S20 subsequent to step S19, the image transformation verification unit 15 (or the image transformation unit 12) generates a transformation image for verification by transforming the input image for verification into the transformation image for verification in accordance with the image transformation parameters calculated in step S37. The image transformation verification unit 15 detects white lines L1 and L2 in the transformation image for verification and then determines whether or not the white lines L1 and L2 are bilaterally-symmetric in the transformation image for verification (step S21). Then, whether the image transformation parameters calculated in step S37 is proper or not proper is determined on the basis of the symmetrical property of the white lines L1 and L2. The result of the determination herein is notified to the user by use of the display unit 3 or the like.

An entire operation procedure of the visibility support system of FIG. 18 is the same as the one described with reference to FIG. 13 in the first example. In this example, however, the editing processing of step S1 of FIG. 13 includes the processing of steps S30 to S37 of and S19 to S23 of FIG. 19.

Accordingly, in a case where the visibility support system is configured in the manner described in this example, the center line of the image in the vertical direction and the vehicle body center line of the vehicle 100 (the vehicle body center line on the image) can coincide with each other in the output image after the editing processing, and the influence of “misaligned camera direction” or “camera position offset” can be eliminated. As to the other points as well, the same effects as those in the cases of the first and second examples can be achieved.

Hereinafter, several modified techniques of the aforementioned technique according to the third example will be exemplified.

In the aforementioned technique of calculating image transformation parameters, which is described above with reference to FIG. 20 and the like, the end points P1 to P4 are handled as the feature points. However, by use of first to fourth markers (not shown) detectable by the image processor 2b of FIG. 18, the image transformation parameters can be derived by handling the markers as the respective feature points. For example, the first to fourth markers are arranged at the same positions of the end points P1 to P4, respectively (in this case, the white lines do not have to be drawn on the road surface). Then, by performing the same processing as that of the aforementioned technique described with reference to FIG. 19, the same image transformation parameters as those in the case where the end points P1 to P4 are used as the feature points can be obtained (the end points P1 to P4 are only replaced with the first to fourth markers).

Moreover, it is also possible to allow the feature point detector 22 of FIG. 18 to include a white line detection function. In this case, the adjustment image generation unit 21 can be omitted, and a part of the processing of FIG. 19, using the adjustment image generation unit 21, can be omitted as well. Specifically, in this case, the feature point detector 22 is allowed to detect the white lines L1 and L2 both existing in the editing image, and further to detect the coordinate values (a total of four coordinate values) of both end points of each of the white lines L1 and L2 on the editing image. Then, by transmitting the detected coordinate values as the coordinate values of the respective feature points to the image transformation parameter calculator 14, the same image transformation parameters as those obtained in the case of using the aforementioned guidelines can be obtained without a need for performing the guideline adjustment processing. However, the accuracy of the calculation of the image transformation parameters is more stable when the guidelines are used.

The technique not using the guidelines can also be applied to the case where the image transformation parameters are derived by use of the aforementioned first to fourth markers, as a matter of course. In this case, the feature point detector 22 is allowed to detect the first to fourth markers existing in the editing image, and further to detect the coordinate values (a total of four coordinate values) respectively of the markers on the editing image. Then, by transmitting the detected coordinate values as the coordinate values of the respective feature points to the image transformation parameter calculator 14, the same image transformation parameters as those obtained in the case of using the aforementioned guidelines can be obtained. It should be noted that as is well known, the number of feature points may be equal to or greater than four. Specifically, the same image transformation parameters can be obtained as those obtained in the case where the aforementioned guidelines are used on the basis of coordinate values of any number of feature points, provided that the feature points are at least four.

Moreover, it is possible to omit the processing of steps S19 to S23 from the editing processing of FIG. 19 by omitting the image transformation verification unit 15 of FIG. 18.

### <<Variations or the Like>>

A subject matter described for a certain example in this description can be applied to the other examples unless there is a discrepancy. In such a case, it should be understood that there is no difference in reference numerals (such as a difference in reference numerals 2, 2a and 2b). As a variation or an explanatory note of the aforementioned embodiment, annotations 1 to 4 will be hereinafter described. Contents described in the annotations may be optionally combined unless there is a discrepancy.

### [Annotation 1]

The technique of deriving image transformation parameters by use of parking lanes each formed in white color on the road surface (in other words, the white lines) is described above as a typical example. The parking lanes, however, do not have to be necessarily in white color. Specifically, instead of the white lines, the image transformation parameters may be derived by use of parking lanes formed with a color other than white.

### [Annotation 2]

In the third example, an example using the guidelines as adjustment indicators each for specifying the corresponding display position of each of the end points of the white lines on the display screen. However, it is also possible to use adjustment indicators in any form as long as the display positions of the end points of the white lines on the display screen can be specified by some form of a user instruction.

### [Annotation 3]

The functions of the image processor 2, 2a or 2b respectively of FIG. 4, 15 or 18 can be implemented by hardware or software, or a combination of hardware and software. It is also possible to write a part of or all of the functions implemented by the image processor 2, 2a or 2b as a program, and then, the part of or all of the functions are implemented by executing the program on a computer.

### [Annotation 4]

For example, one may consider that the driving support system includes the camera 1 and the image processor (2, 2a or 2b), and may further include the display unit 3 and/or the operation unit 4.

What is claimed is:

1. A driving support system obtaining images as first and second editing images upon receipt of a given instruction to derive parameters, the images being respectively captured at first and second points, and the images each including two feature points,
wherein, in real space, the two feature points included in each of the first and second editing images are arranged at symmetrical positions with respect to the center line of a vehicle body in a traveling direction of the vehicle, and the first and second points are different from each other due to the moving of the vehicle,
the driving support system comprising:
a camera configured to be installed on a vehicle and capture the images around the vehicle;
a feature point position detector configured to detect the positions of four feature points on the first and second editing images, the four points formed of the two feature points included in each of the first and second editing images;
an image transformation parameter deriving unit configured to derive image transformation parameters respectively on the basis of the positions of the four feature points; and
an image transformation unit configured to generate an output image by transforming each of the images captured by the camera into the output image in accordance with the image transformation parameters, and then to output a picture signal representing the output image to a display unit.

2. The driving support system according to claim 1, wherein
the image transformation parameter deriving unit derives the image transformation parameters in such a manner that causes the center line of the vehicle body and a center line of the image to coincide with each other in the output image.

3. The driving support system according to claim 1, wherein
the camera captures a plurality of candidate images as candidates of the first and second editing images after the instruction to derive the parameters is received, and
the feature point position detector defines first and second regions being different from each other in each of the plurality of candidate images, and then, handles a first candidate image of the plurality of candidate images as the first editing image, the first candidate image including the two feature points extracted from the first region, while handling a second candidate image of the plurality of candidate images as the second editing image, the second candidate image including the two feature points extracted from the second region.

4. The driving support system according to claim 1, wherein
first and second parking lanes commonly used in both of the first and second editing images are formed in parallel with each other on a road surface on which the vehicle is arranged,
the two feature points included in each of the first and second editing images are end points respectively of the first and second parking lanes, and
the feature point position detector detects the positions of the four feature points by detecting one end point of the first parking lane of each of the first and second editing images and one end point of the second parking lane of each of the first and second editing images.

5. The driving support system according to claim 4, further comprising:
a verification unit configured to determine based on an input image for verification whether or not the image transformation parameters are proper, by using, as the input image for verification, any one of the first editing image, the second editing image and an image captured by the camera after the image transformation parameters are derived, wherein
the first and second parking lanes are drawn on the input image for verification, and
the verification unit extracts the first and second parking lanes from a transformation image for verification obtained by transforming the input image for verification in accordance with the image transformation parameters, and then determines whether or not the image transformation parameters are proper on the basis of a symmetric property between the first and second parking lanes on the transformation image for verification.

6. A vehicle comprising the driving support system according to claim 1 installed therein.

7. A driving support system obtaining images as editing images upon receipt of a given instruction to derive parameters, the images each including four feature points,
the driving support system comprising:
a camera configured to be installed on a vehicle and capture the images around the vehicle;
an adjustment unit configured to cause the editing images to be displayed on a display unit with adjustment indicators, and to adjust display positions of the adjustment indicators in accordance with a position adjustment instruction given from an outside of the system in order to make the display positions of the adjustment indicators correspond to the display positions of the four feature points on the display screen of the display unit;
a feature point position detector configured to detect the positions of the four feature points on each of the editing image from the display positions of the adjustment indicators after the adjustments are made;
an image transformation parameter deriving unit configured to derive image transformation parameters respectively on the basis of the positions of the four feature points; and
an image transformation unit configured to generate an output image by transforming each of the images captured by the camera into the output image in accordance with the image transformation parameters, and then to output a picture signal representing the output image to a display unit,
wherein the image transformation parameter deriving unit derives the image transformation parameters in such a manner that causes a center line of the vehicle body and a center line of the image in a traveling direction of the vehicle to coincide with each other on the output image.

8. The driving support system according to claim 7, wherein
the four feature points are composed of first, second, third and fourth feature points,
one straight line connecting the first and second feature points and other straight line connecting the third and fourth points are in parallel with the center line of the vehicle body in real space, and
the editing image is obtained in a state where a center line between the one straight line and the other straight line overlaps with the center line of the vehicle body in real space.

9. The driving support system according to claim 7, wherein the four feature points are end points of two parking lanes formed in parallel with each other on a road surface on which the vehicle is arranged.

10. A vehicle comprising the driving support system according to claim 7 installed therein.

11. A driving support system obtaining images as editing images upon receipt of a given instruction to derive parameters, the images each including four feature points,
the driving support system comprising:
a camera configured to be installed on a vehicle and capture the images around the vehicle;
a feature point position detector configured to detect positions of the four feature points on each of the editing images, the four feature points being included in each of the editing images;
an image transformation parameter deriving unit configured to derive image transformation parameters respectively on the basis of the positions of the four feature points; and
an image transformation unit configured to generate an output image by transforming each of the images captured by the camera into the output image in accordance with the image transformation parameters, and then to output a picture signal representing the output image to a display unit,
wherein the image transformation parameter deriving unit derives the image transformation parameters in such a manner that causes a center line of the vehicle body and a center line of the image in a traveling direction of the vehicle to coincide with each other on the output image.

12. The driving support system according to claim 11, wherein
the four feature points are composed of first, second, third and fourth feature points,
one straight line connecting the first and second feature points and other straight line connecting the third and fourth points are in parallel with the center line of the vehicle body in real space, and
the editing image is obtained in a state where a center line between the one straight line and the other straight line overlaps with the center line of the vehicle body in real space.

13. The driving support system according to claim 11, wherein the four feature points are end points of two parking lanes formed in parallel with each other on a road surface on which the vehicle is arranged.

14. A vehicle comprising the driving support system according to claim 11 installed therein.
